(19) United States
(12) Patent Application Publication
(10) Pub. No.: US 2015/0251099 A1
(43) Pub. Date: Sep. 10, 2015

(54) METHODS AND SYSTEMS FOR MOBILE BASED APPLICATIONS

(71) Applicants: Kevin Lee Soules, Albuquerque, NM (US); Thomas Joseph Quirk, Albuquerque, NM (US); Joseph Anthony Farfel, San Francisco, CA (US)

(72) Inventors: Kevin Lee Soules, Albuquerque, NM (US); Thomas Joseph Quirk, Albuquerque, NM (US); Joseph Anthony Farfel, San Francisco, CA (US)

(21) Appl. No.: 14/643,257

(22) Filed: Mar. 10, 2015

Related U.S. Application Data
(60) Provisional application No. 61/950,217, filed on Mar. 10, 2014.
(60) Provisional application No. 61/950,218, filed on Mar. 10, 2014.
(60) Provisional application No. 62/129,911, filed on Mar. 8, 2015.

(51) Int. Cl. A63F 13/816; A63F 13/35; A63F 13/32; A63F 13/33; A63F 13/216; A63F 13/5375; A63F 13/87; A63F 13/332; A63F 13/211; H04L 29/06; A63F 13/327

(52) U.S. Cl. CPC A63F 13/816; H04L 65/403; A63F 13/35; A63F 13/32; A63F 13/33; A63F 13/327; A63F 13/5375; A63F 13/87; A63F 13/332; A63F 13/211; A63F 13/216

(57) ABSTRACT

A person can use a computing device such as a computer, mobile device, or other such device to record the completion of a task. The task can include any task that is verifiable via the sensors associated with the mobile device. These sensors may be, for example, video, audio, a clock, a timer, still image, accelerometer based, gyro based, GPS location, locations according to triangulation, temperature, barometer, and the like. The task can then be sent to another person in the form of a challenge to do something better. The other person can then record a responsive task and send it to the challenger. The decision as to if the challenge has been met or beat can be decided by the challenger or someone else including a large voting audience. In some embodiments, a large number of people can respond to the challenge.

### CROSS REFERENCE TO RELATED APPLICATIONS

This patent application claims the priority and benefit of U.S. provisional patent application 61/950,217, entitled “Rad Hard, pre-2013 System and Method Notes”, filed on Mar. 10, 2014, of U.S. Provisional Patent Application No. 61/950,218 entitled “METHODS AND SYSTEMS FOR MOBILE BASED APPLICATIONS” filed Mar. 10, 2014, and of U.S. provisional patent application 62/129,911 entitled “METHODS AND SYSTEMS FOR MOBILE BASED APPLICATIONS” filed Mar. 8, 2015. This patent application therefore claims priority to U.S. Provisional Patent Application Ser. No. 61/950,217, U.S. Provisional Patent Application Ser. No. 61/950,218, and U.S. Provisional Patent Application Ser. No. 62/129,911, which are incorporated herein by reference in their entireties.

### TECHNICAL FIELD

The present invention is generally related to methods, systems, and apparatus for mobile applications. The invention is further related to methods and systems for computer implement applications.

### BACKGROUND OF THE INVENTION

Mobile and computer based applications have become increasingly popular. Therefore a need exists for new methods, systems, and apparatuses that can be used for mobile and computer based applications. Past developments and descriptions of the prior art are of recorded in various patents and patent applications. The following applications are therefore cross-referenced and incorporated by reference herein in their entirety:
“Data Transfer and Synchronization System,” U.S. Pat. No. 6,671,757, issued Dec. 30, 2003;
“Data Transfer and Synchronization System,” U.S. Pat. No. 6,694,336 issued Feb. 17, 2004;
“Data Transfer and Synchronization System,” U.S. patent application Ser. No. 09/491,675, filed Jan. 26, 2000;
“Acquisition and Synchronization of Digital Media to a Personal Information Space,” U.S. Pat. No. 7,587,446, issued Sep. 8, 2009;
“Touch Screen Device, Method, and Graphical User Interface for Determining Commands by Applying Heuristics,” U.S. Pat. No. 7,479,949 issued Jan. 20, 2009;
“Mobile Device Streaming Media Application,” U.S. Pat. No. 8,516,063, issued Aug. 20, 2013; and
“Automatic Personalization of Downloadable Mobile Apps,” U.S. patent application Ser. No. 13/295,748 published on May 16, 2013 and having Publication No 2013/0124606.

The patent applications listed above and incorporated by reference in their entirety are here briefly discussed below to call attention to their teachings.

U.S. Pat. No. 6,694,336, U.S. Pat. No. 6,671,757, and U.S. patent application Ser. No. 09/491,675 disclose methods and systems for synchronizing personal information including that which is conventionally found in desktop applications, personal digital assistants, palm computers, website calendar, and address services, as well as any content in the personal information space including file systems, contact information, and/or calendaring information. In one aspect, the systems disclosed in U.S. Pat. No. 6,694,336, U.S. Pat. No. 6,671,757, and U.S. patent application Ser. No. 09/491,675 comprise a series of device engines that can be utilized on or in conjunction with any personal information manager application or device, on servers, or both, which can connect via a communications network, such as the Internet, to transfer information in the form of differenced data between respective applications and respective devices. In essence, the systems of U.S. Pat. No. 6,694,336, U.S. Pat. No. 6,671,757, and U.S. patent application Ser. No. 09/491,675 create a personal information space or personal information store that is comprised of the set of transactions that define the movement of information between one device, the intermediate storage server, and other devices, and which is unique to an individual user or identifier. For these teachings, amongst others, U.S. Pat. No. 6,694,336, U.S. Pat. No. 6,671,757, and U.S. patent application Ser. No. 09/491,675 are herein incorporated by reference in their entireties

U.S. Pat. No. 7,587,446 expands on U.S. Pat. No. 6,694,336, U.S. Pat. No. 6,671,757, and U.S. patent application Ser. No. 09/491,675 to include further types of content such as digital media including video data (such as movies), image data (such as pictures), and audible data (such as music or voice mail). For these teachings, amongst others, U.S. Pat. No. 7,587,446 is herein incorporated by reference in its entireties.

U.S. Pat. No. 7,479,949 (“the '749 patent”) is the now infamous “Jobs Patent” spanning 364 pages and teaching a substantial portion of the state of the art in smartphone technology circa 2007. The '749 patent provides detailed device architecture, input devices, output devices, user interfaces, hardware components, software components, and sensors that are often included in mobile devices. The 749 patent also details client-server paradigms, remote processing, remote data storage, remote data access, remote data synchronization, and many of the other aspects of today's connected devices. In a nutshell, the 749 patent teaches many of the aspects of mobile devices that millions of users have come to expect and that many application developers rely on. It is for the detailed breadth of its teachings of mobile device technology and related infrastructure that the '749 patent is herein incorporated by reference in its entirety.

U.S. Pat. No. 8,516,063 (“the '063 patent”) teaches a networked architecture (i.e., “cloud” or “cloud based”) of mobile devices, servers, and communications for accepting and delivering messages and for streaming content. The '063 patent also details systems and methods for monetizing the acceptance, processing, and delivering of messages. It is for its teachings regarding cloud based messaging, cloud based content streaming, and cloud based monetization that the '063 patent is incorporated herein in its entirety.

U.S. patent application Ser. No. 13/295,748 teaches systems and methods for user identification and authentication to thereby simplify or otherwise improve on the personalization of a mobile device application that are used and distributed in cloud based environments. It is for these, amongst other, teachings that U.S. patent application Ser. No. 13/295,748 is herein incorporated by reference in its entirety.

### BRIEF SUMMARY

The following summary is provided to facilitate an understanding of some of the innovative features unique to the embodiments and is not intended to be a full description. A full appreciation of the various aspects of the embodiments can be gained by taking the entire specification claims, drawings, and abstract as a whole.

It is, therefore, an aspect of the embodiments that a first user produces and issues a challenge to a second user. The challenge contains a challenge task that is a recording of movements made by the first user during an activity such as skiing, snowboarding, jumping rope, or jumping on a pogo stick. The challenge is to do better or do something better. The second user then produces a response that contains a response task. As with the challenge task, the response task is a recording of movements. The movements can be a recording of sensor outputs such as the sensors now common in cell phones and other mobile device. Those sensors include accelerometers, gyroscopes, magnetometers, and GPS receivers.

It is another aspect of the embodiments that the challenge can include a description of the challenge task. The challenge task can be textual, audible, or otherwise observable by the challenged person.

It is a further aspect of the embodiments that the person challenged can be an individual, such as a friend on a social media web site, can be the entire world, or can be some other grouping of people.

It is a yet further aspect of the embodiments that the challenger can rate the response by accepting that the response meets or beats the challenge or asserting that the response doesn't meet or beat the challenge. The challenge and response can be submitted to an audience that can collectively decide how the challenge and response compare. When the challenge is issued to more than one person, then the audience can judge the challenge and a large number of responses.

### BRIEF DESCRIPTION OF THE DRAWINGS

The accompanying figures, in which like reference numerals refer to identical or functionally similar elements throughout the separate views and which are incorporated in and form a part of the specification, further illustrate aspects of the embodiments and, together with the background, brief summary, and detailed description serve to explain the principles of the embodiments.

FIG. 1 illustrates a block diagram of a computing system that executes programming for implementing the methods and systems disclosed herein and in accordance with aspects of the embodiments;

FIG. 2 illustrates a graphical representation of a network of data-processing systems in which aspects of the present invention may be implemented in accordance with aspects of the embodiments;

FIG. 3 illustrates a computer or mobile software system, which may be employed for directing the operation of the data-processing systems such as computing system 100 depicted in FIG. 1, and in accordance with aspects of the embodiments;

FIG. 4 illustrates a high level flow diagram of a first user challenging many people in accordance with aspects of the embodiments; and

FIG. 5 is a high level block diagram of users challenging and responding to each other in accordance with aspects of the embodiments.

### DETAILED DESCRIPTION

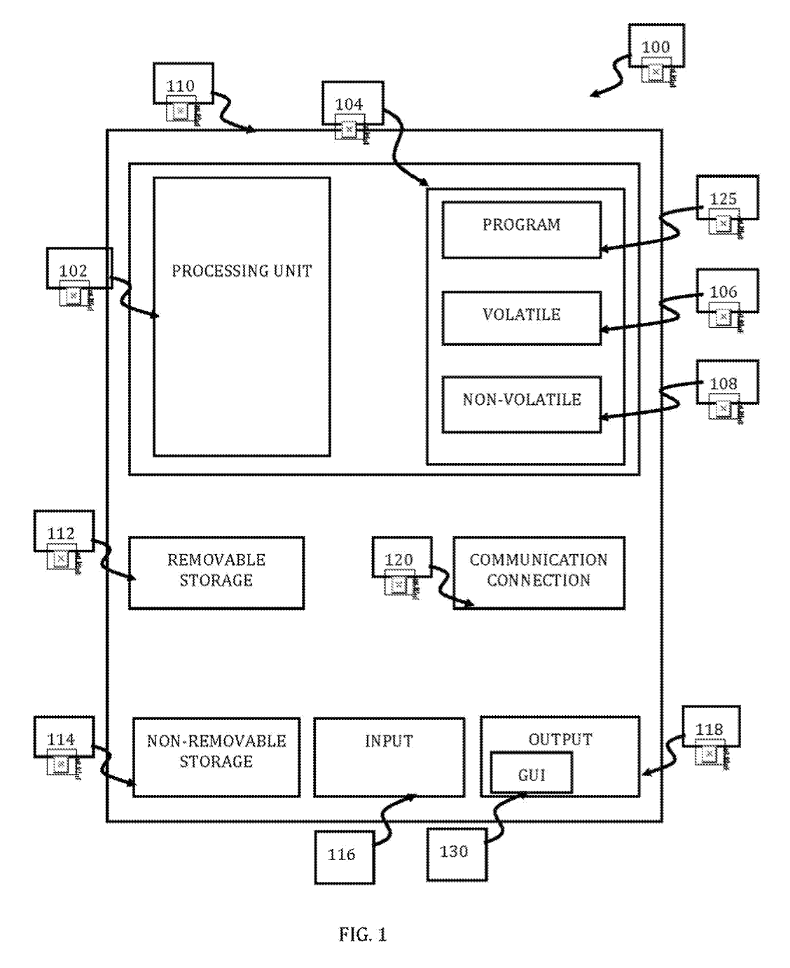

The particular values and configurations discussed in these non-limiting examples can be varied and are cited merely to illustrate at least one embodiment and are not intended to limit the scope thereof. In general, the figures are not to scale. FIGS. 1-3 are provided as exemplary diagrams of data-processing environments in which embodiments of the present invention may be implemented.

Provisional Patent Applications 61/950,217, 61/950,218, and 62/129,911, which are also incorporated herein by reference in their entireties, discuss various mobile games and aspects of those games. Those aspects include the recordation of movement via accelerometer, gyroscope, magnetometer, and GPS. Those aspects also include the design and workings for social gaming including movement based games, challenge based games, and location based games including pogo sticks, jumping rope, snowboarding, and finding other people and things. Other disclosed games include picture sharing/ranking and a type of tag. Further aspects include the monetization of games, computer, network architecture, communications, content screening, and rating challenges and responses. It is for these, amongst other, teachings that Provisional Patent Applications 61/950,217, 61/950,218, and 62/129,911 are herein incorporated by reference in their entirety.

It should be appreciated that FIGS. 1-4 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computing system 100 that executes programming for implementing the methods and systems disclosed herein is shown in FIG. 1. A general computing device in the form of a computer or mobile device 110 may include a processing unit 102, memory 104, removable storage 112, and non-removable storage 114. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data, including data comprising frames of video.

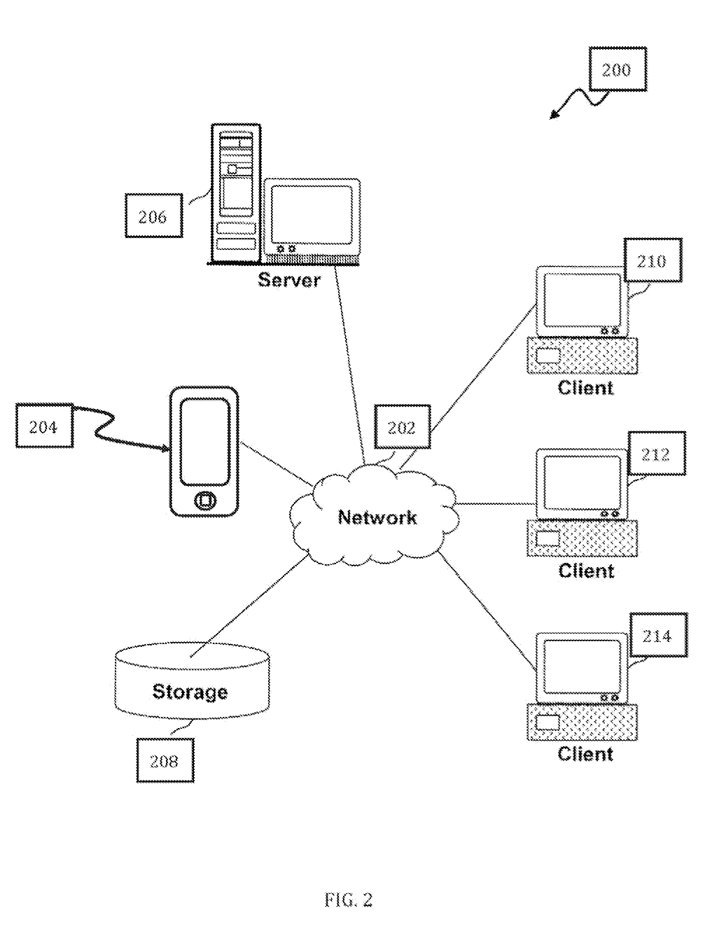

Computer 110 may include or have access to a computing environment that includes input 116, output 118, and a communication connection 120. The computer may operate in a networked environment using a communication connection to connect to one or more remote computers or devices. The remote computer may include a personal computer (PC), server, router, network. PC, a peer device or other common network node, or the like. The remote device may include a photographic camera, video camera, tracking device, or the like. The communication connection may include a Local Area Network (LAN), a Wide Area Network (WAN) or other networks. This functionality is described in more fully in the description associated with FIG. 2 below.

Output 188 is most commonly provided as a monitor, but may include any computer output device. Output 118 may also include a data collection apparatus associated with computer system 100. In addition, input 116, which commonly includes a computer keyboard and/or pointing device such as a computer mouse, track pad, or the like, allows a user to select and instruct computing system 100. A user interface can be provided using output 118 and input 116. Output 118 may function as a display for displaying data and information for a user and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and choking with a user input device 116 such as, for example, a pointing device such as a mouse and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module 125, which can be representative of other modules described herein, are stored on a computer-readable medium and are executable by the processing unit 102 of computer 110. Program module 125 may include a computer or mobile application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 is a network of computers in which embodiments of the present invention may be implemented. Note that the system 200 can be implemented in the context of a software module such as program module 125. The system 200 includes a network 202 in communication with one or more clients 210, 212, and 214. Network 202 is a medium that can be used to provide communications links between various devices and computers connected together within a networked data processing system such as computer system 100. Network 202 may include connections such as wired communication links, wireless communication links, or fiber optic cables. Network 202 can further communicate with one or more servers 206, one or more external devices such as a mobile device 204, and a memory storage unit such as, for example, memory or database 208.

In the depicted example, mobile device 204 and server 206 connect to network 202 along with storage unit 208. In addition, clients 210, 212, and 214 connect to network 202. These clients 210, 212, and 214 may be, for example, personal computers, network computers, or other mobile devices including cellular phones, smartphones, Personal Digital Assistants, tablet devices, and the like. Computer system 100 depicted in FIG. 1 an be, for example, a client such as client 210, 212, and/or 214

Computing system 100 can also be implemented as a server such as server 206, depending upon design considerations. In the depicted example, server 206 provides data such as boot files, operating system images, applications, application updates, data storage, databases, and database management applications to clients 210, 212, and 214, and/or to mobile device 204. Clients 210, 212, and 214 and mobile device 204 are clients to server 206 in this example. Network data-processing system 200 may include additional servers, clients, and other devices not shown Specifically, clients may connect to any member of a network of servers, which provide equivalent content.

In the depicted example, network data-processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

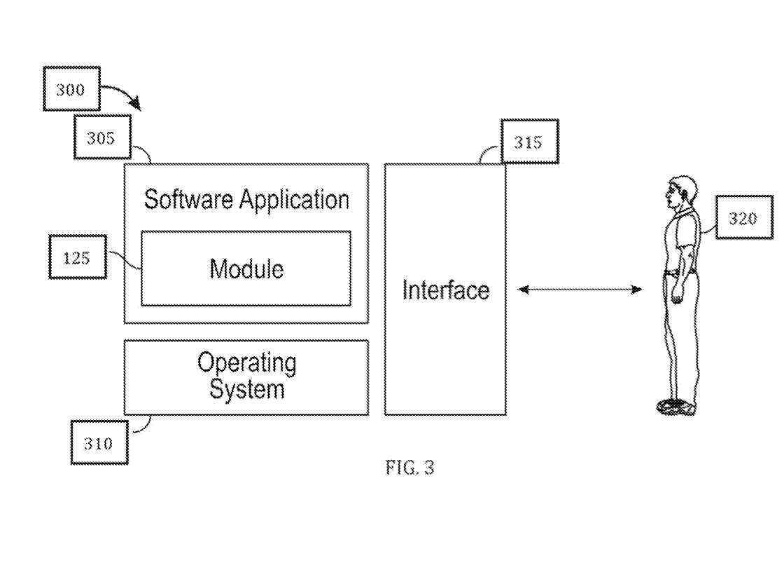

FIG. 3 illustrates a computer or mobile software system 300, which may be employed for directing the operation of the data-processing systems such as computing system 100 depicted in FIG. 1. Software application 305, may be stored in memory 104, on removable storage 112 or on non-removable storage 114 shown in FIG. 1, and generally includes and/or is associated with a kernel or operating system 310 and a shell or interface 315. One or more application programs, such as module(s) 125, may be “loaded” (i.e., transferred from removable storage 112 into the memory 104) for execution by the data-processing system 100. The data-processing system 100 can receive user commands and data through user interface 315, which can include input 116 and output 118, accessible by a user 320. These inputs may then be acted upon by the computing system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked personal computers, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application such as a computer program designed to assist in the performance of a specific task such as word processing, accounting, inventory management, etc.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

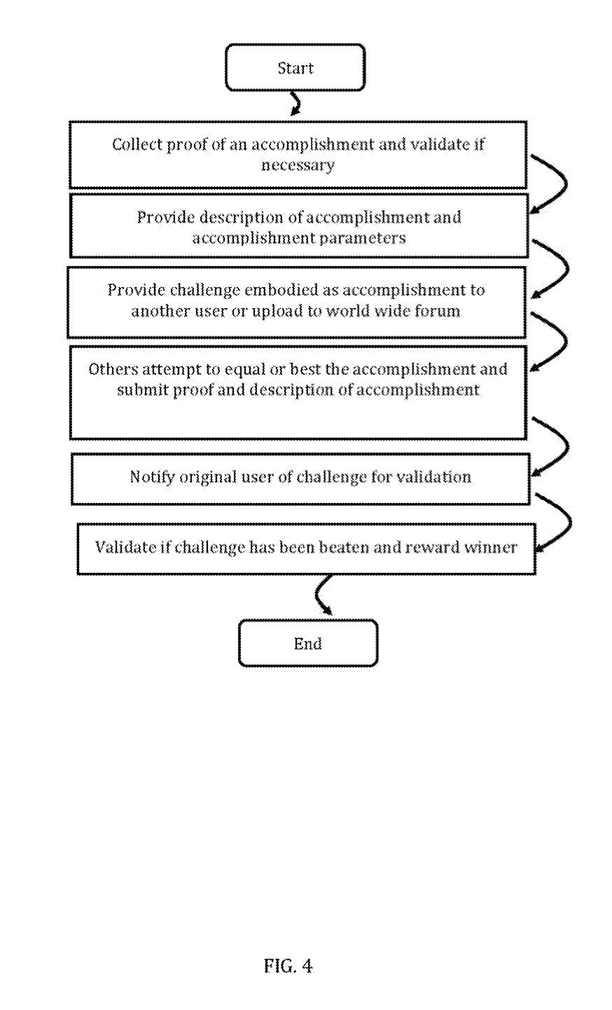

FIG. 4 illustrates a high level flow diagram of a person issuing a challenge to many people. After the start, the person collects proof of an accomplishment and validates it if necessary. For example, the person can record a trip down a ski run or some other activity. Next, the user provides a description and parameters for the task. The description can be textual, audio, or some other means that the challenged people can understand. Next, the challenged people attempt to meet or beat the challenge and submit proof and a description of their accomplishment. The original person who issued the challenge is alerted for validation. Once alerted, the challenge issuer validates if the challenge has been beaten and awards the winner.

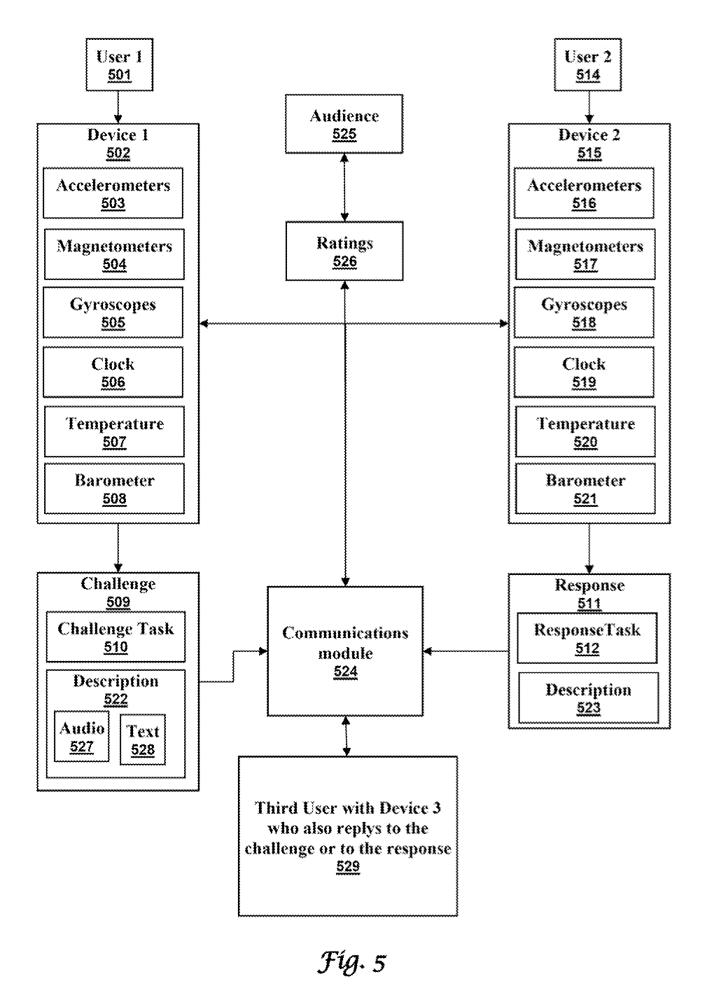

FIG. 5 is a high level block diagram of users challenging and responding to each other in accordance with aspects of the embodiments. A first user 501 issues a challenge 509 to a second user 514. The challenge includes a recorded challenge task 510. The first user 501 can record the challenge task 510 by interacting with device 1 502, perhaps a smartphone, and causing it to record data provided by the sensors 503-508. The challenge 509 also includes a description 522 that can be audio 527, text 528, or both. First user 501 can record the description by interacting with device 1 502 which can also have a video camera, microphone, and real or virtual keyboard.

The second user 514 receives the challenge 509 by way of a communications module 524 and provides a response 511. The response 511 contains a response task 512 and description 523. The second user 514 can record the response task 512 by interacting with device 2 515, perhaps a smartphone, and causing it to record data provided by the sensors 516-521. The response 511 also includes a description 523. Note that in some embodiments device 1 502 and device 2 515 can be in direct contact.

An audience 525 an review the challenge 509 and response 511 and provide rankings 526 to clarify if the response equaled or bested the challenge. Some embodiments will provide a numerous of other people 2 to respond to the challenge 509, to the responses 511, and to other wise compete.

Software applications described herein relate to a method system and apparatus for a social networking platform. The platform employs a mobile or computing device to record user accomplishments and challenge others to equal these achievements.

In one embodiment, a user of the software application can use a computing device such as a computer, mobile device, or other such device to record the completion of a task. The task can include any task that is verifiable via the sensors associated with the mobile device. These sensors may be, for example, video, audio, a clock, a timer, still image, accelerometer based, gyro based, GPS location, locations according to triangulation, temperature, barometer, and the like.

The user employs one or more of the sensors above to document the accomplishment of a task. Optionally, the user may add a description of the achievement input through text, voice recording, or other means. The user's accomplishment and a description associated with the accomplishment are thusly saved as digital information in the computing device associated with the software application. The software application can be a web-page or mobile application (app).

The user's accomplishment can then be uploaded to a server associated with the mobile application or web-page for storage and redistribution. In one example, the proof in form of a video can be loaded to a web service application such as youtube.com where it is stored.

The user may select to challenge another selected user of the software application, such as a social media type friend, identified by the user, or alternatively may choose for the accomplishment to be made viewable by all or some of the general public using the software application.

Once the user “challenges” a friend, the accomplishment data is provided from the server or directly from the user's computing device to the challenged user, such as the social media friend. The second user receives the challenge data in a cleanly formatted manner so that the second user can understand the accomplishment and can review the description of the accomplishment provided by the first user. The second user can be given the option to accept the challenge.

If the second user accepts the challenge, the user takes advantage of the same sensors and others available on the second user's device to attempt to equal or better the accomplishment of the first user. If the second user believes they have equal or bested the first user's accomplishment, they may provide the data indicative of their own accomplishment back to the first user or to the server which in turn provides the first user the data indicative of the accomplishment.

The first user is now provided the option of accepting the second user's accomplishment, attempting to overcome the second user's accomplishment, or may challenge the validity of the accomplishment.

If the first user chooses to accept the second user's accomplishment, the second user is deemed the winner and provided a reward by the software application. If the first user decides to attempt to overcome the challenge, the process is repeated for the first user, until the first user is able to achieve an equal or greater accomplishment.

If the user chooses to challenge the validity, the accomplishment can be provided to the server and/or application for crowd sourcing. In the crowd sourcing stage, other users of the software application can review the original challenge from the first user and the response accomplishment by the second user. The crowd sourcing is used to determine if the response accomplishment is sufficiently valid. This may be achieved via voting or other such known method. The users who participate in crowd sourcing the determination of whether the accomplishment is valid can be provided an incentive to participate, such as in application currency, credit, achievement, elevated status designation, or other such reward.

Alternatively, the first and second user may agree to pay or otherwise reward a subset of specific application users (such as social media friends) or software application administrators to determine if the accomplishment is valid.

If the accomplishment of first user is validated but the response accomplishment by the second user is not, the first user is deemed the winner and provided some reward. However, if both the first user and second user response accomplishment is validated, the second user is deemed the winner and provided a reward.

In another embodiment, a user may challenge a subset of application users or all application users in a “worldwide” style challenge. In this embodiment, the methods for collecting the user accomplishment remain the same. However, one the accomplishment is loaded to the server, any user of the application may attempt to equal or best the challenge. Every time a user submits an accomplishment that replaces the original accomplishment, it can be crowd sourced as discussed above or otherwise validated. If it is validated, the new accomplishment replaces the old accomplishment but remains available for other users to attempt to overcome.

For any of the above embodiments, the first user or a subsequent user can offer a bounty. The user can suggest or post a challenge along with a monetary or other such bounty. The user can establish parameters that must be accomplished to best the first user's accomplishment. If a subsequent user completes the challenge, the user collects the bounty, but if the second user fails, the second user is required to pay the bounty to the first user.

For any of the above embodiments, the application can be formed to allow the original poster of the challenge to set time limits and specific requirements for the challenge to be met or bested. This can include time, location, distance, speed, acceleration, sound, video, numerical, and other parameters that must be met. Statistics regarding the challenge and any subsequent attempts at the challenge by the user or others can be collected by the software application. These statistics can be provided to the user and other users if desired.

User achievements can be automatically uploaded and posted to social media outlets. The server and/or a database can store all challenges. Users can tag each challenge with a description or the challenge can be tagged using a crowd sourcing approach. The challenges can then be sorted by the software application according to the tag by category or other means for easy searching by other users.

The software application can provide each user a user account to store the user data, statistics, login name, password, available funds, achievements, rewards, and other such information. The user may edit and update the user profile and add funds to the user account using paypal, credit card, bitcoin, or other such means. Necessary security methods can be used to protect this information. The user account can be further used to connect the user with other users in a social network style arrangement.

In summary the methods and systems include the following features:

internet connected forum for challenging others, with proof attached

video based

motion based

all phone sensors can be used to confirm completion

challenge friends

challenge the world

crowd source refereeing

pay to have challenge confirmed

social media connectivity

stats keeping

tag based sorting

reward system for winning challenge

internal rewards

challenger offers bounty

security features

In another embodiment, a software application can provide a social media filtering system. A social media filtering system and method can include a software application running on a mobile device, computer system or other such system. The system may further include a backend server.

When a user of the software application connects to the software application, the user is provided a list of supported social messaging services. These services can include facebook, twitter, instagram, sms messaging, email, etc. The software application is then connected with the selected services.

When the user chooses to post to one of the selected social media services, the user's message is first provided to or intercepted by the software application. The social media message can then be screened using a number of methods. If the message is deemed to include content which may be objectionable, the application service alerts the user that the message includes possibly objectionable content. The objectionable content may be identified. The user can then review the possibly objectionable content. If the user agrees, the user can select to delete or modify the message. If the message is modified, it can be resubmitted to the mobile application for review. If the user selects to post the message, the message is then posted on the social media service in the usual manner.

In one embodiment, when the user posts the message, the message can be reviewed via a text reviewer or other means for objectionable words or phrases. The message can also be provided to a server to be reviewed for objectionable words or phrases. If the message does not have any of the pre-determined words or phrases, the message is posted to the social media service as usual. If the message does include the words or phrases, a warning is provided to the user as described above.

In other embodiments, when the user submits a message for posting, the message can be provided to server that has a review mechanism for investigating the content of the message. The investigation can be done by a human being, AI enabled machine or other such means. The message can be reviewed to determine if it is offensive or could be construed as offensive. The method described above can then be repeated as described above.

It should be appreciated that when a user submits the message, it can be provided to the software application or server anonymously so that the content of the message is not linked to a specific user and cannot therefore be traced back to the user. Different levels of message screening can be provided according to the users preferences. For example, the messages can be screened according to the time they are sent and for specific content, such as posts directed at other users names, racially based, bigoted, homophobic, gender based, curse words, etc.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one skilled in the art, the present invention can be embodied as a method, data processing system, or computer program product. Accordingly, the present invention may take the form of an entire hardware embodiment, an entire software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages such as the “C” programming language, in a visually oriented programming environment such as, for example, Visual Basic, or in functional programming languages such as LISP or Erlang.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network, e.g., WiFi, Wimax, 802.xx, and cellular network or the connection may be made to an external computer via most third party supported networks (for example, through the Internet using an Internet Service Provider).

The invention is described in part above with reference to flowchart illustrations and/or block diagrams of methods, systems, computer program products, and data structures according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

Note that computer program instructions and other process-readable media discussed herein may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A system for a first user to issue a challenge to a second user and for verifying the issued challenge, the system comprising:
a first device associated with a plurality of first device sensors wherein the first user interacts with the first device to produce the challenge wherein the challenge comprises a challenge task recorded via the first device sensors;
wherein the challenge is communicated to a second user who accepts the challenge;
wherein the second user has a second device associated with a plurality of second device sensors;
wherein the second user interacts with the second device to produce a response comprising a response task recorded via the second device sensors; and
wherein the first device receives the response and presents the response to the first user.

2. The system of claim 1 wherein the challenge further comprises a description wherein a person observing the description understands the challenge and wherein the second user accepts the challenge after observing the description.

3. The system of claim 1 wherein the challenge task and the response task are recorded via at least one accelerometer.

4. The system of claim 3 wherein the challenge task and the response task are also recorded via at least one gyroscope.

5. The system of claim 3 wherein the challenge task and the response task are also recorded via at least one magnetometer.

6. The system of claim 5 wherein the challenge task and the response task are also recorded via a global positioning system receiver.

7. The system of claim 1 wherein the challenge task and the response task are recorded via a global positioning system receiver.

8. The system of claim 1 wherein the challenge further comprises an audible description wherein a person observing the audible description understands the challenge and wherein the second user accepts the challenge after observing the description.

9. The system of claim 1 wherein the challenge further comprises a textual description wherein a person observing the textual description understands the challenge and wherein the second user accepts the challenge after observing the description.

10. A system for a first user to issue a challenge to a second user and for verifying the issued challenge, the system comprising:
a communications module in communication with a first device and a second device wherein the first device comprises a plurality of first device sensors and wherein the second device comprises a plurality of second device sensors;
a challenge comprising a challenge task wherein the first user interacts with the first device to record the challenge task via the first device sensors, and wherein the system communicates the challenge to the second user; and
a response comprising a response task recorded by the second user via the second device sensors, wherein the second user observes the challenge and thereafter records the response task, and wherein the system communicates the response to the first user.

11. The system of claim 10 further comprising a rating wherein the rating indicates that the response meets or exceeds the challenge, wherein the first user observes the rating via the first device, and wherein the second user observes the rating via the second device.

12. The system of claim 10 further comprising a reply comprising a reply task recorded by the first user via the first device sensors wherein the system communicates the reply to the second user.

13. The system of claim 10 further comprising a reply comprising a reply task recorded by a third user via a plurality of third device sensors wherein the system is in communication with a third device comprising the third device sensors, wherein the system communicates the response to the third user, and wherein the system communicates the reply to the first user and to the second user.

14. The system of claim 13 further comprising a rating wherein the rating indicates a relative ranking of the challenge, the response, and the reply, wherein the first user observes the rating via the first device, wherein the second user observes the rating via the second device, and wherein the third user observes the rating via the third device.

15. The system of claim 14 wherein the challenge further comprises a description comprising an audible description and a textual description wherein a person observing the description understands the challenge and wherein the second user accepts the challenge after observing the description.

16. The system of claim 15 wherein the challenge task and the response task are recorded via at least one accelerometer, at least one gyroscope, at least one magnetometer, and a global positioning system receiver.

17. The system of claim 16 further comprising a rating module wherein a plurality of observers interact with the rating module to individually provide a plurality of individual ratings of the challenge, the response, and the reply, and wherein the rating module produces the rating based on individual rankings.

18. A processor-readable medium storing code representing instructions to cause a process for issuing a challenge from a first user to a second user and for verifying the issued challenge, the code comprising instructions to:
communicate with a first device and a second device wherein the first device comprises a plurality of first device sensors and wherein the second device comprises a plurality of second device sensors;
produce a challenge comprising a challenge task wherein the first user interacts with the first device to record the challenge task via the first device sensors;
communicate the challenge to the second user by way of the second device;
produce a response comprising a response task recorded by the second user via the second device sensors, wherein the second user observes the challenge and thereafter interacts with the second device to record response task; and
communicate the response to the first user by way of the first device.

19. The processor-readable medium of claim 18 wherein the challenge task and the response task are recorded via at least one accelerometer, at least one gyroscope, at least one magnetometer, and a global positioning system receiver.

20. The processor-readable medium of claim 18 further comprising instructions to:
communicate with a third device comprising a plurality of third device sensors;
to communicate the response to a third user by way of the third device;
produce a reply comprising a reply task wherein the third user interacts with the third device to record the reply task via the third device sensors;
to communicate the reply to the first user and to the second user; and
to produce a rating wherein the rating indicates a ranking of the challenge, the response, and the reply, wherein the first user observes the rating via the first device, wherein the second user observes the rating via the second device, and wherein the third user observes the rating via the third device;
wherein the challenge further comprises a description comprising an audible description and a textual description;
wherein a person observing the description understands the challenge; and
wherein the third user accepts the challenge after observing the description.
